(19) United States
(12) Patent Application Publication
(10) Pub. No.: US 2014/0373637 A1
(43) Pub. Date: Dec. 25, 2014

(54) CPU PRESSURE TESTING DEVICE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: ZHAN-YANG LI, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/261,599

(22) Filed: Apr. 25, 2014

(30) Foreign Application Priority Data
Jun. 20, 2013 (CN) 2013102463963

(51) Int. Cl. G01L 5/00

(52) U.S. Cl. CPC G01L 5/00
USPC 73/804

(57) ABSTRACT

A CPU pressure testing device includes a mounting bracket, a CPU simulating member, a heat sink, and a pressure display. The mounting bracket includes a base portion and an engaging member connected to the base portion. The CPU simulating member includes a CPU simulating body and a pressure sensor placed on the CPU simulating body. The CPU simulating member is placed on the base portion. The heat sink is placed on the CPU simulating member to contact the pressure sensor. The pressure display is connected to the pressure sensor. The engaging member engages the base portion to press the heat sink onto the pressure sensor, and the pressure display displays a pressure value.

### FIELD

The present disclosure relates to pressure testing devices, and particularly to a central processing unit (CPU) pressure testing device.

### BACKGROUND

A CPU is mounted to a base of a printed circuit board. A heat sink is mounted on the CPU to dissipate heat generated by the CPU. An engaging member is mounted on the heat sink to secure the heat sink on the CPU. However, the CPU may be damaged due to undue pressure from the engaging member.

### BRIEF DESCRIPTION OF THE DRAWINGS

Many aspects of the embodiments described herein can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a CPU pressure testing device in accordance with an embodiment.

FIG. 2 is a pre-assembled view of the CPU pressure testing device of FIG. 1.

FIG. 3 is another pre-assembled view of the CPU pressure testing device of FIG. 1.

FIG. 4 is an assembled view of the CPU pressure testing device of FIG. 1 .

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

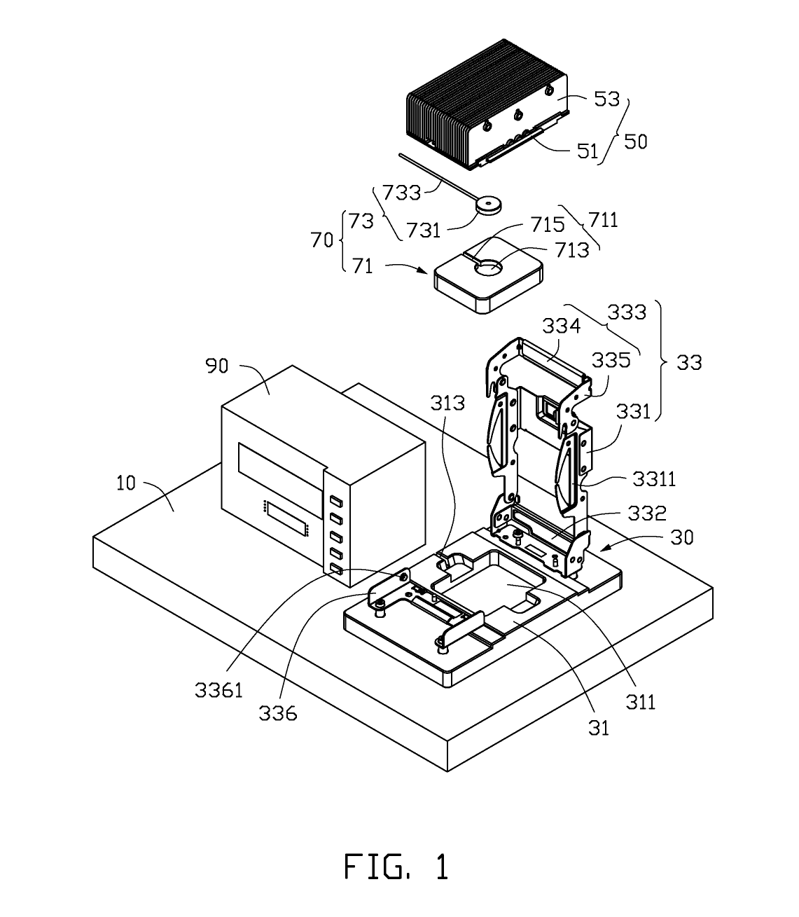

FIG. 1 illustrates an embodiment of a CPU pressure testing device. The CPU pressure testing device includes a base panel 10, a mounting bracket 30, a heat sink 50, a CPU simulating member 70, and a pressure display 90 mounted to the base panel 10.

The mounting bracket 30 includes a base portion 31 secured on the base panel 10 and an engaging member 33 pivotally mounted to the base portion 31. The base portion 31 includes a base body 310 and a mounting portion 332 secured to the base body 310. The base body 310 defines a recess 311 and a slot 313 communicating with the recess 311. The engaging member 33 includes a pressing element 331 pivotally mounted to the mounting portion 332 and an engaging element 333 pivotally mounted to the pressing element 331. The pressing element 331 includes two pressing arms 3311. The engaging element 333 includes a handle 334 and two engaging arms 335 extending from opposite sides of the handle 334. The two engaging arms 335 are pivotally mounted to the two pressing arms 3311. Each engaging arm 335 defines an engaging cutout 3351. The base portion 31 further includes two clasping portions 336. Each clasping portion 336 includes a clasping protrusion 3361. The clasping protrusion 3361 is configured to be engaged in the engaging cutout 3351. The heat sink 50 includes a base body 51 and a plurality of fins 53 extending from the base body 51.

The CPU simulating member 70 includes a CPU simulating body 71 and a pressure sensor 73. The CPU simulating body 71 defines an opening 711. The opening 711 defines a circular wide part 713 and a narrow part 715 communicating with the wide part 713. The pressure sensor 73 includes a main body 731 and a cable 733 connected to the main body 731. The cable 733 passes through the narrow part 715 and the slot 313 to be connected to the pressure display 90. The CPU simulating body 71 is mounted in the recess 311.

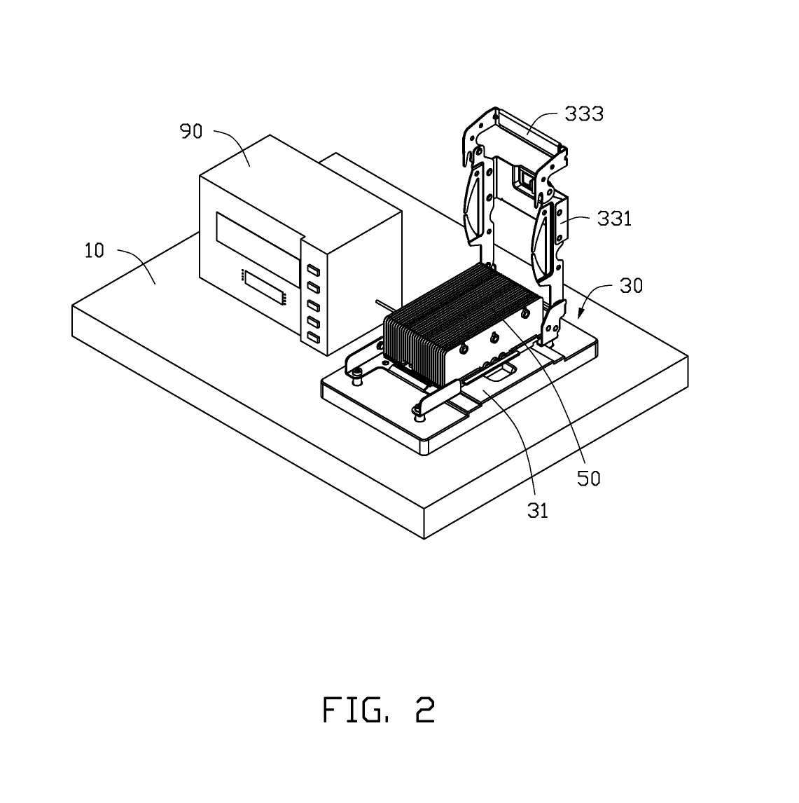

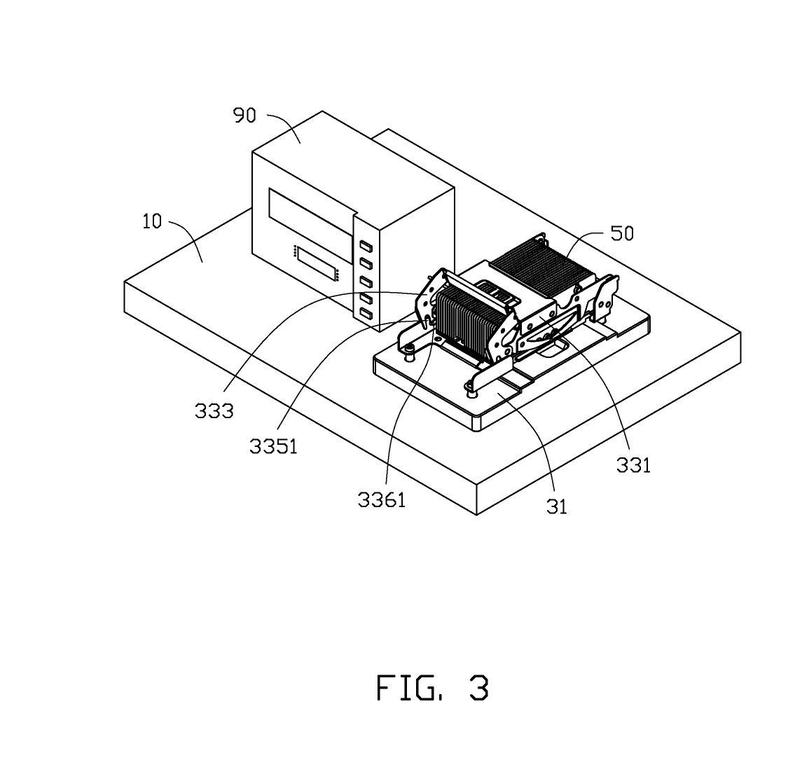

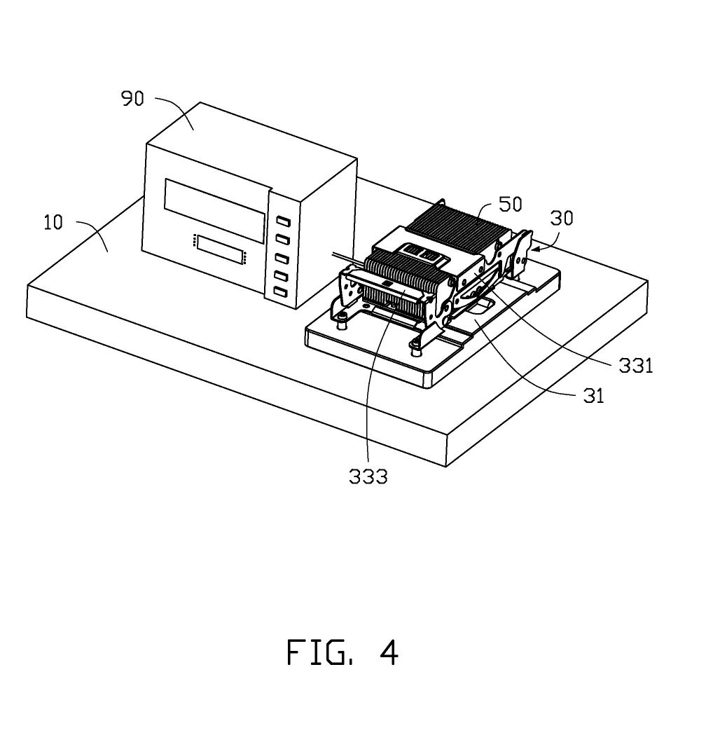

FIGS. 2-4 illustrate that during assembly, that the main body 731 of the pressure sensor 73 is placed in the wide part 713 of the opening 711 to enable the cable 733 to be located in the narrow part 715. The CPU simulating member 70 is placed in the recess 311 to enable the cable 733 to be located in the slot 313. The heat sink 50 is placed on the CPU simulating member 70 to enable the base portion 51 of the heat sink 50 to contact the main body 731 of the pressure sensor 73. The pressing element 331 of the engaging member 33 rotates along a first rotation direction to enable the pressing arms 3311 of the pressing element 331 to press on the base portion 51 of the heat sink 50. The engaging element 333 rotates along the first rotation direction to enable the engaging cutout 3351 to align with the clasping protrusion 3361 of the clasping portion 336. The engaging element 333 continues to rotate to enable the engaging cutout 3351 to engage with the clasping protrusion 3361, thereby securing the heat sink 50 on the CPU simulating member 70. The pressure display 90 can be started up to test the pressure value of the CPU simulating member 70.

During disassembly, the engaging element 333 rotates along a second rotation direction to enable the engaging cutout 3351 to disengage from the clasping protrusion 3361. The engaging element 333 continues to rotate to enable the pressing element 331 to separate from the heat sink 50.

It is to be understood that even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure. The embodiments described herein are illustrative and are not to be construed as limiting the following claims.

What is claimed is:

1. A CPU pressure testing device comprising:
a mounting bracket, the mounting bracket comprising a base portion and an engaging member connected to the base portion;
a CPU simulating member, the CPU simulating member comprising a CPU simulating body and a pressure sensor placed on the CPU simulating body, the CPU simulating member configured to be received by the base portion;
a heat sink, the heat sink configured to be placed on the CPU simulating member to contact the pressure sensor; and
a pressure display, the pressure display configured to be connected to the pressure sensor;
wherein the engaging member is configured to engage the base portion to press the heat sink on the pressure sensor, and the pressure display is configured to display a pressure value from the pressure sensor.

2. The CPU pressure testing device of claim 1, wherein the base portion defines a recess configured to receive the CPU simulating member.

3. The CPU pressure testing device of claim 2, wherein the pressure sensor comprises a main body and a cable connected to the main body; the heat sink is configured to contact the main body; the base portion defines a slot communicating with the recess; the slot is configured to receive the cable; and the cable is configured to be connected to the pressure display.

4. The CPU pressure testing device of claim 2, wherein the CPU simulating body defines an opening, and the pressure sensor is located in the opening.

5. The CPU pressure testing device of claim 4, wherein the opening defines a wide part and a narrow part communicating with the wide part; the pressure sensor comprises a main body and a cable connected to the main body; the main body is located in the wide part; and the cable is located in the narrow part.

6. The CPU pressure testing device of claim 1, wherein the engaging member is pivotally mounted to the base portion.

7. The CPU pressure testing device of claim 6, wherein the engaging member comprises a pressing element configured to press the heat sink and an engaging element pivotally mounted to the pressing element; the base portion comprises a base body, a mounting portion and a clasping portion mounted on the base body; the CPU simulating member is located on the base body; the mounting portion is pivotally mounted to the pressing element; and the engaging element is configured to engage the clasping portion.

8. The CPU pressure testing device of claim 7, wherein the engaging element comprises a handle and an engaging arm connected to the handle; the engaging arm is pivotally mounted to the pressing element; the engaging arm defines an engaging cutout; the clasping portion comprises a clasping protrusion; the engaging element is configured to rotate to enable the engaging cutout to engage with the clasping protrusion.

9. The CPU pressure testing device of claim 7, wherein the heat sink comprises a base body and a plurality of fins extending from the base body; the base body contacts the pressure sensor; and the pressing element is configured to press the base body.

10. The CPU pressure testing device of claim 1, further comprising a base panel, wherein the base portion and the pressure display are mounted on the base panel.

11. A CPU pressure testing device comprising:
a mounting bracket, the mounting bracket comprising a base portion and an engaging member;
a CPU simulating member, the CPU simulating member comprising a CPU simulating body and a pressure sensor placed on the CPU simulating body, the CPU simulating member configured to be received by the base portion;
a heat sink, the heat sink configured to be placed on the CPU simulating member to contact the pressure sensor, and the pressure sensor located between the base portion and the heat sink; and
a pressure display, the pressure display configured to be connected to the pressure sensor;
wherein the engaging member is configured to press the heat sink on the pressure sensor to be secured to the base portion; and the pressure sensor and the pressure display is configured to display a pressure value from the pressure sensor.

12. The CPU pressure testing device of claim 11, wherein the base portion defines a recess configured to receive the CPU simulating member.

13. The CPU pressure testing device of claim 12, wherein the pressure sensor comprises a main body and a cable connected to the main body; the heat sink is configured to contact the main body; the base portion defines a slot communicating with the recess; the slot is configured to receive the cable; and the cable is configured to be connected to the pressure display.

14. The CPU pressure testing device of claim 12, wherein the CPU simulating body defines an opening, and the pressure sensor is located in the opening.

15. The CPU pressure testing device of claim 14, wherein the opening defines a wide part and a narrow part communicating with the wide part; the pressure sensor comprises a main body and a cable connected to the main body; the main body is located in the wide part; and the cable is located in the narrow part.

16. The CPU pressure testing device of claim 11, wherein the engaging member is pivotally mounted to the base portion.

17. The CPU pressure testing device of claim 16, wherein the engaging member comprises a pressing element configured to press the heat sink and an engaging element pivotally mounted to the pressing element; the base portion comprises a base body, a mounting portion and a clasping portion mounted on the base body; the CPU simulating member is located on the base body; the mounting portion is pivotally mounted to the pressing element; and the engaging element is configured to engage the clasping portion.

18. The CPU pressure testing device of claim 17, wherein the engaging element comprises a handle and an engaging arm connected to the handle; the engaging arm is pivotally mounted to the pressing element; the engaging arm defines an engaging cutout; the clasping portion comprises a clasping protrusion; and the engaging element is configured to rotate to enable the engaging cutout to engage with the clasping protrusion.

19. The CPU pressure testing device of claim 17, wherein the heat sink comprises a base body and a plurality of fins extending from the base body; the base body contacts the pressure sensor; and the pressing element is configured to press the base body.

20. The CPU pressure testing device of claim 11, further comprising a base panel, wherein the base portion and the pressure display are mounted on the base panel.
